(19) United States
(12) Patent Application Publication
(10) Pub. No.: US 2007/0063676 A1
(43) Pub. Date: Mar. 22, 2007

(54) Multiple mode electronic device and method for indicating remaining battery capacity level

(76) Inventor: Shouresh T. Davani, Boynton Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/233,126

(22) Filed: Sep. 22, 2005

(51) Int. Cl. H02J 7/04

(52) U.S. Cl. 320/149

(57) ABSTRACT

A multiple mode electronic device (102) and a method for indicating a remaining battery capacity level are disclosed. The method includes commencing operation using a first operation mode and determining a first remaining battery capacity level (504). The first remaining battery capacity level is displayed (506) using a remaining battery capacity status indicator (304). On commencing a second operation mode (508), a corresponding second remaining battery capacity level is determined (510). The remaining battery capacity status level is displayed (512) by visually altering the remaining battery capacity status indicator without altering the display of the first remaining battery capacity level.

### FIELD OF THE INVENTION

This invention relates in general to the field of electronic devices. More specifically, the invention relates to the display of battery capacity status on electronic devices capable of operating in multiple modes.

### BACKGROUND OF THE INVENTION

Electronic devices have found prevalent use in almost all spheres of life. They have become particularly useful for computational, communication, logistics, and other activities being performed in a portable or mobile manner. This necessitates a power supply backup for the electronic devices. The same is facilitated by the use of rechargeable batteries in the electronic devices.

To enable a user of the electronic device to get a battery recharged well in time and continue using an electronic device without interruptions, the rechargeable battery and a remaining battery capacity level need to be monitored continuously. Further, the user has to be informed of the remaining battery capacity level.

Known methods for informing the users of the remaining battery capacity level include display indicators or remaining battery capacity status indicators for displaying the remaining battery capacity level. These display indicators are displayed on the graphical displays of the electronic devices. These methods further involve determining the expected battery duration for which a remaining battery capacity charge on the battery will last. The expected battery duration is in part calculated from the current load or the power usage rate for the electronic device.

Other methods involve the use of different colors for depicting remaining power levels in a display indicator. For example, green may be used while the power level is above a minimum level, and red may be used for low charge below the minimum level, indicating a need for a recharge.

However, the methods described inform users of the remaining battery capacity level for only a single mode of operation of the electronic device. Electronic devices may have multiple modes of operations, for example, a Global System for Mobile (GSM) communication mode and a Wireless Local Area Network (WLAN) communication mode. Different modes of operation may involve different power usage rates. Furthermore, battery discharge dynamic are not necessarily linear. A high rate of discharge may provide less total charge from a battery than a low rate of discharge. Therefore, the remaining capacity in proportion to the overall capacity may be different for a mode of operation having a high rate of discharge compared with one having a low rate of discharge. Consequently, on switching from a first operating mode to a second operating mode, the remaining capacity of a battery as a proportion of its total cpacity may fluctuate by considerable amounts, causing the capacity display indicator to change up or down significantly, thereby confusing the user. Moreover, the electronic device can quickly run out of power in an alternate mode of operations that has a higher power usage rate. The display indicators give no indication of the expected power levels while using the device in alternate modes of operation.

### BRIEF DESCRIPTION OF THE DRAWINGS

The present invention is illustrated by way of an example, and not limitation in the accompanying figures, in which like references indicate similar elements, and in which:

FIG. 1 is a block diagram illustrating components of a multiple mode electronic device, in accordance with an embodiment of the invention;

FIG. 2 is a block diagram illustrating components of a display indicator module, in accordance with an embodiment of the invention;

FIG. 3 depicts an exemplary graphical display of a multiple mode electronic device, in accordance with an embodiment of the invention;

FIG. 4 depicts a remaining battery capacity status indicator, in accordance with an embodiment of the invention;

FIG. 5 is a flowchart illustrating a method for indicating a remaining battery capacity level in a multiple mode electronic device, in accordance with an embodiment of the invention; and

FIGS. 6 and 7 illustrate a flowchart of a method for indicating a remaining battery capacity level in a multiple mode electronic device, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to aid in understanding embodiments of the present invention.

### DETAILED DESCRIPTION OF THE VARIOUS EMBODIMENTS

Before describing in detail the particular method and system for wireless communication in emergency situations, in accordance with the present invention, it should be observed that the present invention resides primarily in combinations of method steps and apparatus components related to the method and system, for wireless communication in emergency situations. Accordingly, the apparatus components and method steps have been represented where appropriate by conventional symbols in the drawings. These show only the specific details that are pertinent for an understanding of the present invention, so as not to obscure the disclosure with details that will be readily apparent to those of ordinary skill in the art, with the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

Various embodiments of the present invention provide a method for indicating a remaining battery capacity level in a multiple mode electronic device. The multiple mode electronic device operates on electric charge stored on a battery and is capable of operating in at least two modes of operation. Examples of multiple mode electronic devices include mobile phones, Personal Digital Assistants (PDAs), Global Positioning Systems (GPSs) device and portable laptop computers. The multiple mode electronic device commences operation using a first operation mode. A first remaining battery capacity level for the first operation mode is determined. The first remaining battery capacity level is displayed by using a remaining battery capacity status indicator on a graphical display of the multiple mode electronic device.

When the multiple mode communication device commences a second operation mode, a second remaining battery capacity level for the second operating mode is determined in correspondence with the second operating mode's power consumption parameters. The second remaining battery capacity level is displayed by visually altering the remaining battery capacity status indicator. This is achieved without altering the display of the first remaining battery capacity level.

Various embodiments of the present invention also provide a multiple mode electronic device that operates on a battery and is capable of operating in at least two modes of operation. The multiple mode electronic device includes a means for determining a remaining battery capacity level. The remaining battery capacity level is determined for at least two modes of operation of the multiple mode electronic device. The multiple mode electronic device further includes a display indicator module for displaying the remaining battery capacity level for the modes of operation.

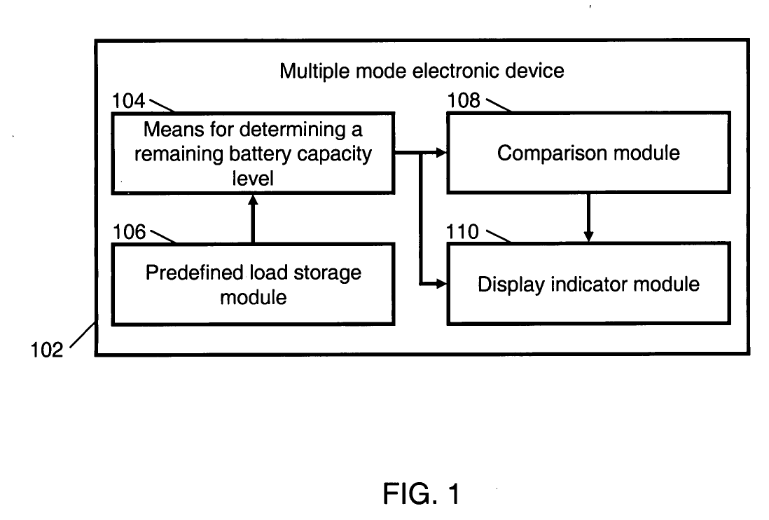

FIG. 1 is a block diagram illustrating components of a multiple mode electronic device 102, in accordance with an embodiment of the invention. The multiple mode electronic device 102 is capable of operating in at least two modes of operation. Examples of operation modes of the multiple mode electronic device 102 include, but are not limited to a Global System for Mobile (GSM) communication mode, a Wireless Local Area Network (WLAN) communication mode, a Global Positioning System (GPS) mode and an Integrated Digital Enhancement Network (iDEN) radio/fax mode. Each of the operation modes has a predefined load that indicates a power usage rate associated with it. A predefined load for an operation mode is used in determining a remaining battery capacity level for the multiple mode electronic device 102, corresponding to the operation mode.

The multiple mode electronic device 102 includes a means for determining the remaining battery capacity level 104, a predefined load storage module 106, a comparison module 108 and a display indicator module 110. In an embodiment of the invention, the remaining battery capacity level is determined based on the present amount of charge stored in the battery and the power consumption parameters of the predefined load. The remaining battery capacity level can be taken to be equal to, for example, the ratio of the present charge and an ohmic model corresponding to the predefined load. The predefined load power consumption parameters can be determined based on experimental usage of the multiple mode electronic device 102 for various modes of operation. The predefined load is stored in the predefined load storage module 106. The predefined load storage module 106 stores predefined loads for each of the operation mode of the multiple mode electronic device 102.

The multiple mode electronic device 102 includes the comparison module 108 for comparing the remaining battery capacity level with a predefined minimum switchover value. The predefined minimum switchover value determines the minimum value of the remaining battery capacity level corresponding to a second operation mode, necessary to enable a switch from a first operation mode to the second operation mode. If the remaining battery capacity level is less than the predefined minimum switchover value, the comparison module 108 is capable of notifying a user of the multiple mode electronic device 102 about an inability to switch from the first operation mode to the second operation mode, as the switching would lead to an immediate powering down of the multiple mode electronic device 102 as a result of the battery voltage falling below a minimum operating level. In an embodiment of the invention, a notification is displayed on a graphical display of the multiple mode electronic device 102, indicating an inability to switch.

The display indicator module 110 displays the remaining battery capacity level. The remaining battery display level is displayed by using a remaining battery capacity status indicator on the graphical display of the multiple mode electronic device 102.

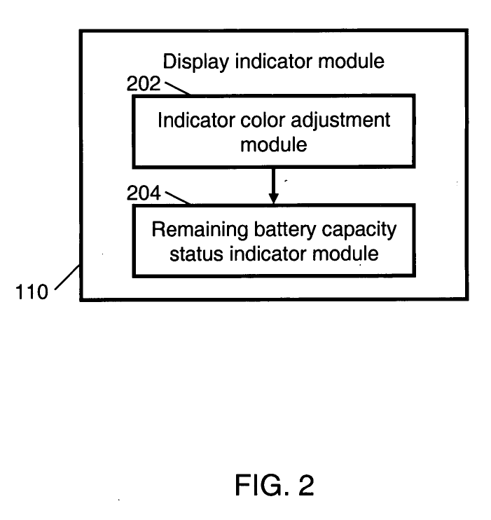

FIG. 2 is a block diagram illustrating components of the display indicator module 110, in accordance with an embodiment of the invention. The components illustrated and referred to herein may be hardware components, software components, or a combination of hardware and software components. The display indicator module 110 includes an indicator color adjustment module 202 and a remaining battery capacity status indicator module 204. The indicator color adjustment module 202 is capable of setting an indicator color to a predefined value. The indicator color is used to represent a portion of the remaining battery capacity status indicator which indicates the remaining battery capacity level. The predefined value of the indicator color is chosen from a plurality of indicator colors that are used to indicate remaining battery capacity levels for at least two modes of operation. This enables the simultaneous display of the remaining battery capacity levels for each of the at least two modes of operation by using the remaining battery capacity status indicator.

The remaining battery capacity status indicator module 204 determines at least one parameter of the remaining battery capacity status indicator. Examples of parameters of the remaining battery capacity status indicator include, but are not limited to, length, color and transparency level of portions of the remaining battery capacity status indicator. The parameter is determined based on the remaining battery capacity level. For example, the length of the remaining battery capacity status indicator can be determined in proportion to the value of the remaining battery capacity level. As another example, a first remaining battery capacity level can be displayed with a lower transparency level than a second remaining battery capacity level.

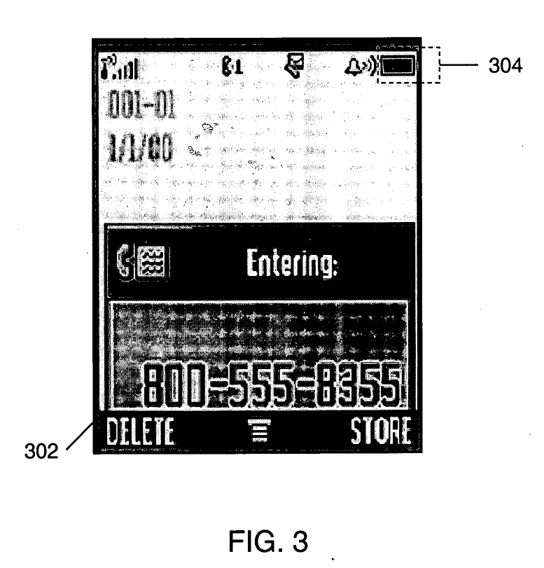

FIG. 3 depicts an exemplary graphical display 302 of the multiple mode electronic device 102, in accordance with an embodiment of the invention. The graphical display may be, for example, a liquid crystal display, or any conventional display used in electronic devices. The graphical display 302 includes a remaining battery capacity status indicator 304. According to the present embodiment of the invention, the remaining battery capacity status indicator 304 displays the remaining battery capacity level for at least two modes of operation.

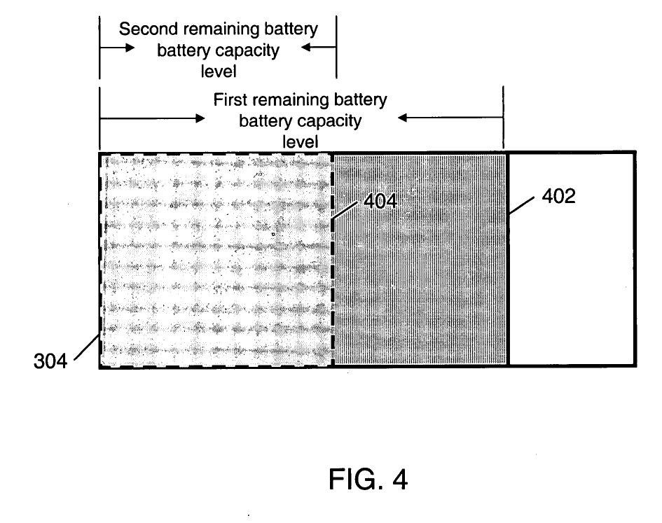

FIG. 4 depicts the remaining battery capacity status indicator 304 which is displayed on a graphical display, in accordance with an embodiment of the invention. A first indicator 402 having a first color, shade, or pattern depicts a first remaining battery capacity level corresponding to the first operation mode. In an embodiment of the invention, the length of the first indicator 402 is in proportion to the first remaining battery capacity level, and may be used as a default battery capacity indicator to be also used when the device is in an idle mode. Similarly, a second indicator 404 having a second color, shade, or pattern depicts a second remaining battery capacity level corresponding to the second operation mode. The remaining battery capacity status indicator 304 is thus capable of simultaneously indicating the remaining battery capacity level for multiple modes of operation of the multiple mode electronic device 102. In an embodiment of the invention, the indicators 402 and 404 are displayed by using different indicator colors, shades, patterns, different transparency levels, or other graphical distinctions, or combinations thereof.

According to the invention, the first and second remaining capacity indicators share the graphical area of the indicator area 304. One of the remaining capacity indicators is therefore overlayed on the other remaining capacity indicator. That is, in the parlance of graphical displays, one remaining capacity indicator is in the foreground while the other remaining capacity indicator is in the background. The remaining capacity indicator corresponding to the mode of operation having the higher discharge rate should be displayed in the foreground as it will typically be shorter, or occupy less of the indicator area 304. However, it is contemplated that the first and second remaining capacity indicators may be swapped, moving one from the foreground to the background and the other from the background to the foreground should their proportions somehow change. Their unique graphical distinction of color, shade, or pattern will be maintained so that the user can readily determine the change from foreground to background.

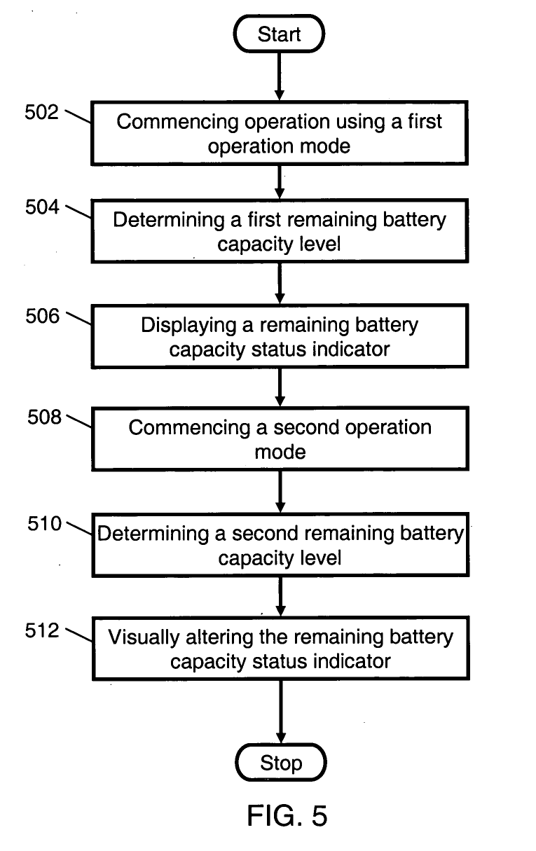

FIG. 5 is a flowchart illustrating a method for indicating the remaining battery capacity level in the multiple mode electronic device 102, in accordance with an embodiment of the invention. At the start of the method, the electronic device is powered up and ready to commence various modes of operation, and may have already made an initial determination of remaining battery capacity, or fetched the last stored capacity values for display. At step 502, the multiple mode electronic device 102 commences operation using a first operation mode. At step 504, the first remaining battery capacity level corresponding to the first operating mode is determined. In an embodiment of the invention, the first remaining battery capacity level is determined based on the current charge on the battery and a predefined load for the first operation mode. At step 506, the first remaining battery capacity level is displayed for a user of the multiple mode electronic device 102. In accordance with an embodiment of the invention, the first remaining battery capacity level is displayed by using the indicator 402 on the remaining battery capacity status indicator 304. It should be noted that steps 504 and 506 may be performed as background processes that are periodically repeated during operation.

At step 508, the second operation mode is commenced. In an embodiment of the invention, this involves the activation of the second operation mode by the user. In another embodiment of the invention, the commencement of the second operation mode involves an automatic activation following the detection of an activation signal or other user input for a second operation mode. Examples of the activation signal or input include a WLAN signal or input and a GPS signal or input. The user may then be informed about the commencement of the second operation mode. The second remaining battery capacity level corresponding to the second operation mode is determined at step 510. In an embodiment of the invention, the second remaining battery capacity level is determined based on the current charge on the battery and a predefined load for the second operation mode.

At step 512, the second remaining battery capacity level is displayed. In accordance with an embodiment of the invention, the second remaining battery capacity level is displayed by using the indicator 404 on the remaining battery capacity status indicator 304. This can be achieved by adding the indicator 404 to the remaining battery capacity status indicator 304 without altering the indicated graphical proportion of the first indicator 402. This enables the simultaneous display of both the first and second remaining battery capacity levels on the remaining battery capacity status indicator 304. As with steps 504 and 506, steps 510 and 512 may be periodically repeated to periodically refresh the second remaining capacity indicator.

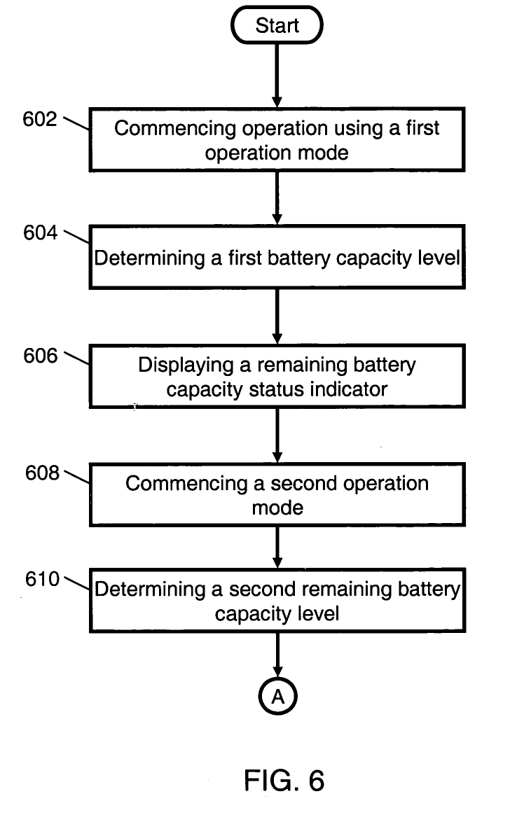

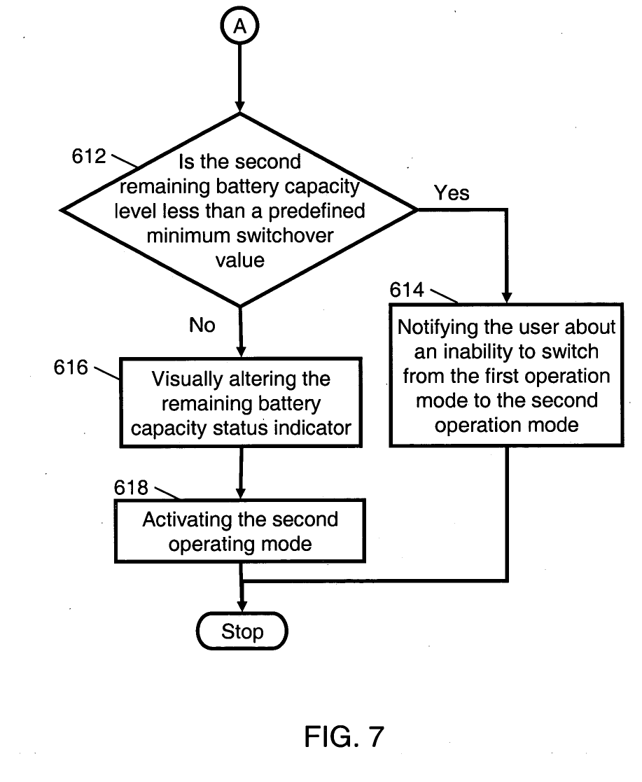

FIGS. 6 and 7 illustrate a flowchart of a method for indicating the remaining battery capacity level in the multiple mode electronic device 102, in accordance with another embodiment of the present invention. The multiple mode electronic device commences operation using the first operation mode at step 602. The first remaining battery capacity level corresponding to the first operation mode is determined at step 604. At step 606, the first remaining battery capacity level is displayed by using the indicator 402 on the remaining battery capacity status indicator 304. Steps 604 and 606 may be periodically repeated.

At step 608, the second operation mode is commenced. The second remaining battery capacity level corresponding to the second operation mode is determined at step 610. At step 612, the second remaining battery capacity level is compared with a predefined minimum switchover value corresponding to the second operation mode. In case the second remaining battery capacity level is less than the predefined minimum switchover value, the user is notified about an inability to switch from the first operation mode to the second operation mode at step 614. The predefined minimum switchover value corresponds to a capacity value that will support operation of the second mode without causing the battery voltage to drop below a minimum operating voltage of the device 102.

However, in case the second remaining battery capacity level is equal to or more than the predefined minimum switchover value, the second remaining battery capacity level is displayed using the indicator 404 on the remaining battery capacity status indicator 304 at step 616. Finally, at step 618, the second operation mode is activated for the multiple mode electronic device 102. In another embodiment of the invention, this involves notifying the user to manually activate the second operation mode. This enables the user to decide if the second operation mode can be enabled depending on the current charge on the battery.

Various embodiments of the invention have the following advantages. A single remaining battery capacity status indicator simultaneously displays the remaining battery capacity level for the at least two modes of operation. Therefore, the user is not alarmed by changes in power usage rates on switching to an alternate operation mode. Various embodiments of the invention enable the user to predict a remaining battery capacity level for the alternate operation mode and decide when to recharge the battery based on the expected usage. Further, various embodiments enable the multiple mode electronic device to decide whether the second operating mode can be activated.

It will be appreciated the mobile communication device 102 described herein may be comprised of one or more conventional processors and unique stored program instructions that control the one or more processors to implement, in conjunction with certain non-processor circuits, some, most, or all of the functions of the multiple mode electronic device and computer program product described herein. The non-processor circuits may include, but are not limited to, a radio receiver, a radio transmitter, signal drivers, clock circuits, power source circuits, and user input devices. As such, these functions may be interpreted as steps of a method to perform the enablement of the enhanced operating mode of the multiple mode electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for indicating a remaining battery capacity level in a multiple mode electronic device, the method comprising:
commencing operation using a first operation mode;
determining a first remaining battery capacity level while commencing the first operation mode;
displaying a remaining battery capacity status indicator corresponding to the first remaining battery capacity level;
commencing a second operation mode;
determining a second remaining battery capacity level while commencing the second operation mode; and
visually altering the remaining battery capacity status indicator to indicate the second remaining battery capacity level without altering the first remaining battery capacity level as indicated by the remaining battery capacity status indicator.

2. A method for indicating a remaining battery capacity level in a multiple mode electronic device as defined in claim 1, wherein the method further comprises comparing the second remaining battery capacity level for the second operation modes, with a predefined minimum switchover value for the second operation mode.

3. A method for indicating a remaining battery capacity level in a multiple mode electronic device as defined in claim 1, wherein the method further comprises notifying a user of the multiple mode electronic device of an inability to switch from the first operation mode to the second operation mode.

4. A method for indicating a remaining battery capacity level in a multiple mode electronic device as defined in claim 1, wherein the method further comprises setting at least one indicator color to a predefined value based on at least one of the first remaining battery capacity level and the second remaining battery capacity level.

5. A method for indicating a remaining battery capacity level in a multiple mode electronic device as defined in claim 1, wherein displaying the remaining battery capacity status indicator comprises determining at least one parameter of the remaining battery capacity status indicator based on at least one of the first remaining battery capacity level and the second remaining battery capacity level.

6. A multiple mode electronic device comprising:
means for determining a remaining battery capacity level for at least two modes of operation of the multiple mode electronic device; and
a display indicator module for displaying the remaining battery capacity level for each of the at least two modes of operation simultaneously by using a remaining battery capacity status indicator.

7. A multiple mode electronic device as defined in claim 6, wherein the multiple mode electronic device further comprises a predefined load storage module for storing a predefined load on a battery for each of the at least two modes of operation of the multiple mode electronic device.

8. A multiple mode electronic device as defined in claim 6, wherein the multiple mode electronic device further comprises a comparison module for comparing the remaining battery capacity level with a predefined minimum switchover value.

9. A multiple mode electronic device as defined in claim 6, wherein the display indicator module comprises an indicator color adjustment module for setting an indicator color to a predefined value based on the remaining battery capacity level.

10. A multiple mode electronic device as defined in claim 6, wherein the display indicator module comprises a remaining battery capacity status indicator module for determining at least one parameter of a remaining battery capacity status indicator based on the remaining battery capacity level.

11. A computer program product for indicating a remaining battery capacity level in a multiple mode electronic device, the computer program product comprising a computer readable medium comprising:
program instruction means for determining a remaining battery capacity level for at least two modes of operation of the multiple mode electronic device; and
program instruction means for displaying the remaining battery capacity level for each of the at least two modes of operation simultaneously, by using a remaining battery capacity status indicator.

12. A computer program product for indicating a power level in a multiple mode electronic device as defined in claim 11, wherein the program instruction means for determining the remaining battery capacity level comprises program instruction means for calculating the remaining battery capacity level based on a current charge on a battery and a set of predefined loads on the battery for the at least two modes of operation.

13. A computer program product for indicating a power level in a multiple mode electronic device as defined in claim 11, wherein the computer program product further comprises program instruction means for comparing the remaining battery capacity level with a minimum predefined switchover value.

14. A computer program product for indicating a power level in a multiple mode electronic device as defined in claim 11, wherein the computer program product further comprises program instruction means for notifying a user of the multiple mode electronic device of an inability to switch from a first mode of operation to a second mode of operation.

15. A computer program product for indicating a power level in a multiple mode electronic device as defined in claim 11, wherein the computer program product further comprises program instruction means for setting at least one indicator color to a predefined value based on the remaining battery capacity level.

16. A computer program product for indicating a power level in a multiple mode electronic device as defined in claim 11, wherein the program instruction means for displaying the battery duration comprises program instruction means for determining at least one parameter of a remaining battery capacity status indicator based on the battery duration.
